(19) United States
(12) Patent Application Publication
(10) Pub. No.: US 2026/0330665 A1
(43) Pub. Date: Oct. 22, 2026

(54) DETERMINING A MEASURE OF CROP HEIGHT

(71) Applicant: AGCO International GmbH, Neuhausen Am Rheinfall (CH)

(72) Inventors: Dan Hermann, Randers (DK); Kenneth During Jensen, Randers (DK)

(21) Appl. No.: 19/486,511

(22) PCT Filed: Apr. 18, 2024
(86) PCT No.: PCT/IB2024/053793

§ 371 Date: Nov. 21, 2025

(30) Foreign Application Priority Data
May 23, 2023 (GB) 2307718.3

(51) Int. Cl. G06T 7/60; A01D 41/06; A01D 41/127; A01D 41/14; G06V 20/10; G06V 20/56

(52) U.S. Cl. CPC G06T 7/60; A01D 41/06; A01D 41/127; A01D 41/141; G06V 20/188; G06V 20/56; G06T 2207/10016; G06T 2207/30188; G06T 2207/30252

(57) ABSTRACT

A mechanism for predicting a measure of crop height. Monocular image data of crop to be harvested is obtained and processed using one or more image processing algorithms to predict the measure of crop height.

### CROSS-REFERENCE TO RELATED APPLICATIONS

Not applicable.

### FIELD

Embodiments of the present disclosure generally relate to the field of combine harvesting.

### BACKGROUND

With ever-increasing population numbers and ongoing interest in more environmentally friendly farming practices, there is an increasing desire to reduce waste when harvesting crop and improve the efficiency of harvesting machinery, such as combine harvesters, forage harvesters and windrowers.

One useful parameter to monitor when harvesting crop with a combine harvester is a measure of crop height. This information can, for instance, be useful for selecting certain settings or positions of harvesting and crop processing elements of the combine harvester for improving the efficiency of harvesting and processing harvested crop.

### BRIEF SUMMARY

The invention is defined by the claims.

According to examples in accordance with an aspect of the invention, there is provided a computer-implemented method of predicting a measure of crop height of crop.

The computer-implemented method comprises obtaining first monocular image data containing a representation of a portion of the crop before harvesting by a harvesting machine, the first monocular image data being captured using a single camera mounted on the harvesting machine; and processing the first monocular image data using one or more image processing algorithms to predict the measure of crop height.

There is proposed a method for processing monocular image data of a crop to predict a measure of the height of the crop (i.e., a crop height). One or more image processing algorithms process the monocular image data in order to determine or derive the height of the crop once it has been harvested.

As previously mentioned, determining the height of a harvested crop is advantageous in selection of certain parameters for elements of a combine harvester. Such elements can include setting a reel height to ensure adequate penetration of the crop for more efficient harvesting of crop and processing of harvested crop, whilst balancing this reel height against a desire to reduce damage to the crop by the reel.

The method may further comprise obtaining second monocular image data containing a representation of stubble and/or ground surface remaining after harvesting of the crop by the harvesting machine and/or a cutting bar of the harvesting machine, wherein processing the first monocular image data comprises processing the first monocular image data and the second monocular image data to predict the measure of crop height.

In some examples, the measure of crop height is a prediction of a distance between a top of the stubble and/or ground surface and/or a cutting bar, represented in the second monocular image data, and a top of the crop, represented in the first monocular image data.

In some examples, the first monocular image data comprises a first sequence of monocular images, each monocular image containing a representation of the portion of the crop before harvesting by the harvesting machine.

The computer-implemented method may further comprise obtaining first movement information identifying a movement of the harvesting machine between capturing adjacent monocular images in the first sequence of monocular images.

The step of processing the first monocular image data may comprise: processing the first sequence of monocular images, and no other image data, together with the first movement information using a first monocular simultaneous localization and mapping, SLAM, algorithm to produce a plurality of first points, each identifying a predicted location of a portion of a top of the crop with respect to a co-ordinate system; and processing the plurality of first points to predict the measure of crop height.

This approach makes use of a SLAM algorithm to effectively track or monitor the top of a crop as depicted in sequential monocular images. It has been recognized that a monocular SLAM technique or algorithm is able to produce a plurality of points in a space or co-ordinate system (e.g., a 3D co-ordinate system) that represent (or are predicted to represent) the top of a crop represented within the (SLAM-processed) sequence of monocular images.

In some examples, the step of processing the plurality of first points comprises: fitting a contour to the first points to produce a first contour that represents the top of the crop; and processing the first contour to predict the measure of crop height.

In some examples, the method comprises obtaining second monocular image data comprising a second sequence of monocular images each containing a representation of stubble and/or ground surface remaining after harvesting of the crop by the harvesting machine; obtaining second movement information identifying a movement travelled by the harvesting machine between capturing adjacent monocular images in the second sequence of monocular images; and processing the second sequence of monocular image data, and no other image data, together with the second movement information using a second monocular simultaneous localization and mapping, SLAM, algorithm to produce a plurality of second points, each identifying a predicted location of a portion of a top of the stubble and/or ground surface represented in the second sequence of monocular images, wherein the step of processing the plurality of first points comprises processing the plurality of first points and the plurality of second points to predict the measure of crop height.

Optionally, the step of processing the plurality of first points comprises fitting a contour to the second points to produce a second contour that represents the stubble and/or ground surface with respect to the co-ordinate system; and the step of processing the first contour comprises processing the first contour and the second contour to predict the measure of crop height.

The step of processing the first contour and the second contour may comprise: identifying a first portion of the first contour; identifying a second portion of the second contour, the first portion of the first contour wholly overlaying the second portion of the second contour in a vertical direction within the co-ordinate system; and determining a vertical distance or average vertical distance within the co-ordinate system between the first portion of the first contour and the second portion of the second contour to predict the measure of crop height of the crop.

The computer-implemented method may be adapted wherein: the first portion of the first contour comprises more than one point of the first contour; the second portion of the second contour comprises more than one point of the second contour; and the vertical distance or average vertical distance is the average vertical difference.

In some examples, in the first sequence of monocular images and the second sequence of monocular images are the same, such that each monocular image contains a representation of a portion of crop before harvesting by the harvesting machine and a portion of a top of the stubble and/or ground surface after harvesting of the crop by the harvesting machine.

In one example, the first movement information is derived from a speed of the harvesting machine and a time elapsed between capturing each monocular image. In another example, the first movement data is derived from navigation information identifying, for each monocular image, a position at which the monocular image was captured. In yet another example, the first movement information is inertia information produced by an inertia measurement unit.

The step of processing the first monocular image data may comprise processing the first monocular image data using a machine-learning method to predict the measure of crop height.

There is also proposed a computer-implemented method of controlling the height of a reel of a header of a harvesting machine. The computer-implemented method comprises: determining the measure of crop height by performing any herein disclosed method; and adjusting the height of the reel of the header responsive to the determined measure of crop height.

There is also provided a computer program product comprising computer program code means which, when executed on a computing device having a processing system, cause the processing system to perform all of the steps of any herein described computer-implemented method.

There is also provided a processing system configured to predict a measure of crop height. The processing system is configured to obtain first monocular image data containing a representation of a portion of the crop before harvesting by a harvesting machine, the first monocular image data being captured using a single camera mounted on the harvesting machine; and process the first monocular image data using one or more image processing algorithms to predict the measure of crop height.

There is also provided an image processing system comprising the processing system and the single camera for capturing the monocular image data.

There is also provided a harvesting machine, such as a combine harvester, comprising the image processing system.

These and other aspects of the invention will be apparent from and elucidated with reference to the embodiment(s) described hereinafter.

### BRIEF DESCRIPTION OF THE DRAWINGS

One or more embodiments of the disclosure will now be described, by way of example only, with reference to the accompanying drawings, in which:

FIG. 1 illustrates a harvesting machine in which embodiments can be employed;

FIG. 2 illustrates a portion of a combine harvester;

FIG. 3 illustrates a header of a harvesting machine;

FIG. 4 is a flowchart illustrating a proposed method;

FIG. 5 is a flowchart illustrating an embodiment of the proposed method;

FIG. 6 is a flowchart illustrating another embodiment of the proposed method;

FIG. 7 illustrates a technique for predicting a measure of crop height;

FIG. 8 illustrates a SLAM algorithm;

FIG. 9 illustrates another proposed method;

FIG. 10 illustrates a proposed system; and

FIG. 11 illustrates a proposed processing system.

### DETAILED DESCRIPTION

The invention will be described with reference to the figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the figures are merely schematic and are not drawn to scale. It should also be understood that the same reference numerals are used throughout the figures to indicate the same or similar parts.

The invention provides a mechanism for predicting a measure of crop height. Monocular image data of crop to be harvested is obtained and processed using one or more image processing algorithms to predict the measure of crop height.

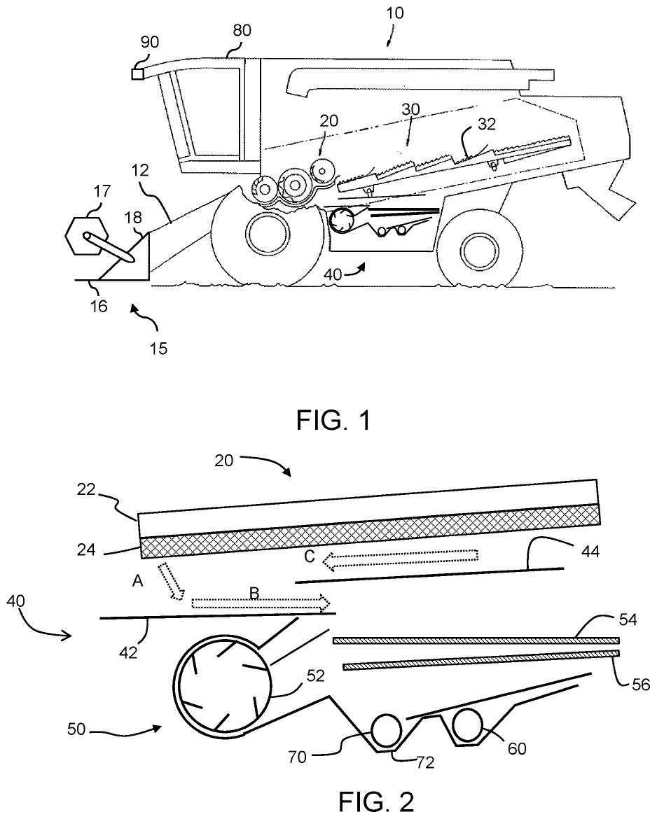

FIG. 1 conceptually illustrates a harvesting machine 10 in the form of a combine harvester, for improved contextual understanding.

More particularly, FIG. 1 shows a known combine harvester 10 in which embodiments may be integrated. The combine harvester includes a threshing unit 20 for detaching grains of cereal from the ears of cereal, and a separating unit 30 which is connected downstream of the threshing unit 20. The grains after separation by the separating device 30 pass to a grain cleaning apparatus 40.

The combine harvester has a front elevator housing 12 at the front of the machine for attachment of a crop cutting head 15 (commonly known as the header). The header 15, when attached, serves to cut and collect the crop material as it progresses across the field. The header 15 comprises a cutter bar 16 that engages with a base of the crop to cut the crop. The header 15 also comprises a reel 17 or harvesting reel. The reel 17 is configured to engage with a top of the crop and encourage or guide the crop into the header. A conveyor 18 is configured to convey the crop, cut by the cutter bar 16, into the elevator housing 12. Generally, the reel comprises a plurality of tine bars (each comprising a plurality of tines) that sequentially engage with the top of the crop as the reel rotates. The tines of each tine bar act to lift and separate the crop, and to guide the crop towards the header, particularly the conveyor 18 of the header.

The crop stream produced in this way by the header 15 is conveyed up through the elevator housing 12 into the threshing unit 20. In the example shown, the threshing unit 20 is a transverse threshing unit, i.e. formed by rotating elements with an axis of rotation in the side-to-side direction of the combine harvester and for generating a tangential flow.

The operation of the combine harvester may be controlled by a control system (not shown). The control system may receive input from a user interface and/or sensing apparatus and control the operation of the various units and apparatus responsive to the received input.

The combine harvester 10 may also comprise a user support 80, e.g. a cab, for housing an operator/individual. The user support will often contain a user interface to allow the operator/individual to influence or control the operation of the elements of the combine harvester (e.g. via the control system). The user interface may also provide information about the combine harvester and/or the status of the combine harvester.

The combine harvester 10 may also comprise a camera 90, for use in embodiments of the invention. The purpose of the camera will be elucidated later in this disclosure.

The threshing unit 20, separating device 30 and grain cleaning apparatus 40 are shown in more detail in FIG. 2.

FIG. 2 shows one particular design for a threshing unit, namely a traverse threshing unit. The transverse threshing unit 20 includes a rotating, tangential-flow, threshing cylinder 22 and a concave-shaped grate 24, sometimes simply called a concave. The threshing cylinder 22 includes rasp bars (not shown) which act upon the crop stream to thresh the grain or seeds from the remaining material, the majority of the threshed grain passing through the underlying grate 24 and onto a stratification pan 42 (also known as the grain pan), which for convenience is in this disclosure considered to be part of the grain cleaning apparatus 40.

The threshing unit 20 also comprises a beater cylinder 25 (also with a transverse rotation axis and creating a tangential flow), downstream of the threshing cylinder and a tangential-flow multi-crop separator cylinder 26 (also with a transverse rotation axis and creating a tangential flow) downstream of the beater cylinder 25.

The threshing unit 20 shown in this example thus has a well-known set of three transversely mounted rollers and cylinders (otherwise known as drums). However, there are other transverse rotation (and hence tangential flow) threshing units. Typically, there is at least one threshing cylinder, and often also a beater cylinder.

The remainder of the crop material including straw, tailings and un-threshed grain are passed from the threshing unit 20 into the separating unit 30 as shown by arrow M.

In the example shown, the separating unit 30 includes a plurality of parallel, longitudinally-aligned, straw walkers 32, and this is suitable for the case of a so-called straw-walker combine. However, the separating unit 30 may instead include one or two longitudinally-aligned rotors which rotate about a longitudinal axis and convey the crop stream rearwardly in a ribbon passing along a spiral path. This is the case for a so-called axial or hybrid combine harvester.

In all cases, the separating unit 30 serves to separate further grain from the crop stream, and this separated grain passes through a grate-like structure onto an underlying return pan 44. The residue crop material, predominantly made up of straw, exits the machine at the rear. Although not shown in FIG. 1, a straw spreader and/or chopper may be provided to process the straw material as required.

The threshing apparatus 20 and separating unit 30 do not remove all material other than grain, “MOG”, from the grain so that the crop stream collected by the stratification pan 42 and return pan 44 typically includes a proportion of straw, chaff, tailings and other unwanted material such as weed seeds, bugs, and tree twigs. The remainder of the grain cleaning apparatus 40 (i.e. a grain cleaning unit 50) is provided to remove this unwanted material thus leaving a clean sample of grain to be delivered to the tank.

For clarity, the term ‘grain cleaning apparatus’ is intended to include the stratification pan 42, the return pan 44 and other parts which form the grain cleaning unit 50 (also known as a cleaning shoe).

The grain cleaning unit 50 also comprises a fan unit 52 and sieves 54 and 56. The upper sieve 54 is known as the chaffer.

The stratification pan 42 and return pan 44 are driven in an oscillating manner to convey the grain and MOG accordingly. Although the drive and mounting mechanisms for the stratification pan 42 and return pan 44 are not shown, it should be appreciated that this aspect is well known in the art of combine harvesters and is not critical to disclosure of the invention. Furthermore, it should be appreciated that the two pans 42, 44 may take a ridged construction as is known in the art.

The grain passing through concave grate 24 falls onto the front of the stratification pan 42 as indicated by arrow A in FIG. 2. This material is conveyed rearwardly (in the direction of arrow B in FIG. 2) by the oscillating motion of the stratification pan 42 and the ridged construction thereof. Material passing through the grate of the separator apparatus 30 falls onto the return pan 44 and is conveyed forwardly by the oscillating motion and ridged construction thereof as shown by arrow C.

It is noted that “forwardly” and “rearwardly” refer to direction relative to the normal forward direction of travel of the combine harvester.

When the material reaches a front edge of the return pan 44 it falls onto the stratification pan 42 and on top of the material conveyed from the threshing unit 20 as indicated by arrow B.

The combined crop streams thus progress rearwardly towards a rear edge of the stratification pan 42. Whilst conveyed across the stratification pan 42, the crop stream, including grain and MOG, undergoes stratification wherein the heavier grain sinks to the bottom layers adjacent stratification pan 42 and the lighter and/or larger MOG rises to the top layers.

Upon reaching the rear edge of the stratification pan 42, the crop stream falls onto the chaffer 54 which is also driven in a fore-and-aft oscillating motion. The chaffer 54 is of a known construction and includes a series of transverse ribs or louvers which create open channels or gaps therebetween. The chaffer ribs are angled upwardly and rearwardly so as to encourage MOG rearwardly whilst allowing the heavier grain to pass through the chaffer onto an underlying second sieve 56.

The chaffer 54 is coarser (with larger holes) than second sieve 56.

It is known for chaffer 54 to include an inclined rear extension section (not shown), and MOG which reaches the rear section either passes over the rear edge and out of the machine or through the associated grate before being conveyed to a returns auger 60 for re-threshing in a known manner. The majority of materials passing through the rear end of the chaffer 54 is un-threshed tailings.

Grain passing through chaffer 54 is incident on the lower sieve 56 which is also driven in an oscillating manner and serves to remove tailings from the stream of grain before being conveyed to on-board tank (not shown) by grain collecting auger 70 which resides in a transverse trough 72 at the bottom of the grain cleaning unit 50. Tailings blocked by sieve 56 are conveyed rearwardly by the oscillating motion thereof to a rear edge from where the tailings are directed to the tailings processing unit 60 or returns auger for reprocessing in a known manner.

The flow of material over the end of the stratification pan 42, shown as arrow D, is known as a cascade. It is desirable for this cascade to form a thin layer so that the airflow from the fan unit 52 is able to pass through the layer and lift the MOG away from the grains.

To assist this operation it is also known to have an additional cascade pan 46 between the stratification pan 42 and the chaffer 54. The grain and chaff then initially falls from the stratification pan 42 onto the cascade pan 46 before falling from the rear edge thereof onto the chaffer 54. The cascade pan 46 has a grid to convey long straw and weeds rearwardly and away from the cascading grain flow. The cascade pan assists the separation of grain from MOG.

In this case, fan unit 52 delivers a portion of a cleaning airstream rearwardly between the stratification pan 42 and the cascade pan 46 and another portion rearwardly between the chaffer 54 and the cascade pan 46, and between the sieves.

The fan unit 52 thus generates a cleaning air stream which is directed through the falling grain and chaff cascade. The fan 52 rotates on a transverse axis in a known manner and includes a plurality of impellor blades which draw in air from the transverse ends open to the environment and generate an air stream as explained above in a generally rearward direction. The air stream creates a pressure differential across the chaffer 54 and sieve 56 to encourage lighter MOG rearwardly and upwardly whilst allowing the grain to pass through the chaffer 54 and the sieve 56.

The operation of the various units and elements of the combine harvester may be controlled by a control unit (not shown). For instance, the control unit may modify one or more operational components of the combine harvester.

The present disclosure relates to approaches for predicting a measure of crop height before being harvested by a harvesting machine. Proposed approaches make use of first monocular image data of a top of crop (to be harvested) to predict or determine the measure of crop height.

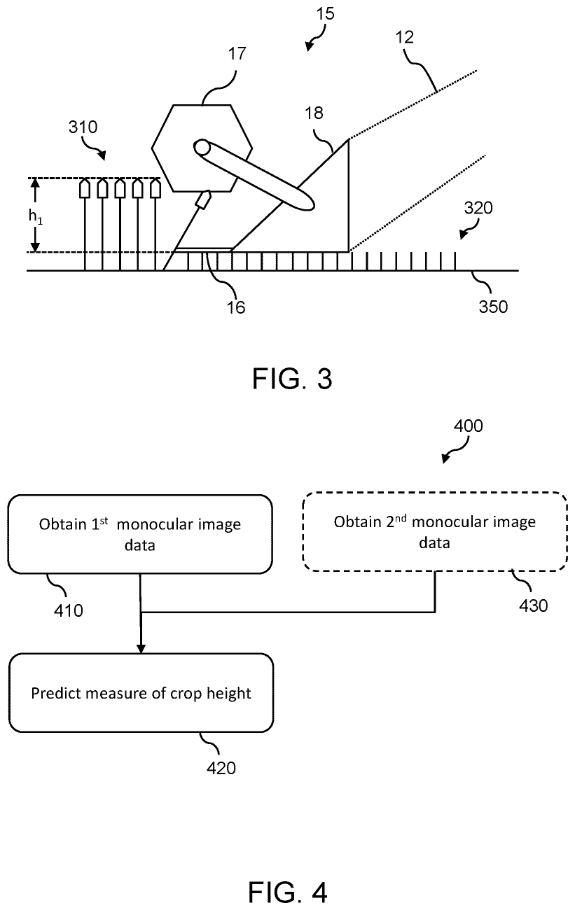

FIG. 3 conceptually illustrates a portion of a harvesting machine for further contextualization. In particular, FIG. 3 illustrates the header of a harvesting machine during a harvesting procedure.

Crop 310 is cut and gathered by the header 15 of the harvesting machine, as previously explained. More specifically, the cutting bar 16 cuts the crop 310 at a base of the crop. Preferably, the reel is positioned to engage with an upper part of the crop 310 to perform crop separation and guiding towards the header 15.

The crop leaves behind stubble 320 after being cut. The stubble therefore represents the remaining part of the original crop that has not been cut by the cutting bar, and is therefore usually the height of the cutting bar from the ground surface 350.

It would be desirable to determine or predict a measure h₁ of crop height. The measure of crop height may, for instance, be a prediction of a distance between the cutting bar 16 and the top (or uppermost part) of the crop 310. This would facilitate accurate control over the placement of the reel with respect to the crop. As mentioned, it is desirable for the reel to be positioned so that it engages with the top of the crop. However, if the reel is positioned too low, then it can cause damage to the crop. Accurate determination of the measure h₁ of the crop height can facilitate more appropriate and specific control over at least the reel height to balance between these two desires.

However, other measures of crop height could be predicted using herein proposed techniques, such as a predicted height of the crop from a ground surface, a predicted length or height of the crop after is has been harvested and so on. Embodiments may be adapted accordingly, some examples of which are later described.

FIG. 4 is a flowchart illustrating a computer-implemented method 400 of predicting a measure of crop height of crop. The computer-implemented method 400 comprising:

The method 400 comprises a step 410 of obtaining first monocular image data containing a representation of a portion of the crop before harvesting by a harvesting machine, the first monocular image data being captured using a single camera mounted on the harvesting machine.

As previously mentioned, the first monocular image data is captured by a single camera mounted on the harvesting machine, e.g., the camera 90 illustrated in FIG. 1. The single camera may iteratively produce monocular images of a view that includes a crop ahead of the harvesting machine, i.e., a crop to be harvested. Step 410 may comprise obtaining the first monocular image data from this camera.

The method 400 also comprises a step 420 of processing the first monocular image data using one or more image processing algorithms to predict the measure of crop height.

Optionally, the method 400 also comprises a step 430 of obtaining second monocular image data containing a representation of stubble and/or ground surface remaining after harvesting of the crop by the harvesting machine and/or a representation of the cutting bar during harvesting of the crop. In this approach, step 420 comprises processing the first monocular image data and the second monocular image data to predict the measure of crop height.

Like the first monocular image data, the second monocular image data is captured by a single camera mounted on the harvesting machine. The single camera may iteratively produce monocular images of a view that includes the stubble or ground surface remaining after harvesting of the crop by the harvesting machine and/or the cutting bar during harvesting. In preferred examples, a single camera captures the first and second monocular image data. However, this is not essential. Rather, different cameras may capture the first and second monocular image data—e.g., a first camera on the front of the harvesting machine may capture the first monocular image data and a second camera on the rear of the harvesting machine may capture the second monocular image data.

The method 400 may comprise other steps (not shown), e.g., obtaining movement information or the like. The inclusion of other steps may depend upon the precise procedure that is used in step 420 to predict the measure of crop height, as will become clear from the following examples.

Various approaches for performing step 420 are envisaged, a non-exhaustive number of which are hereafter described.

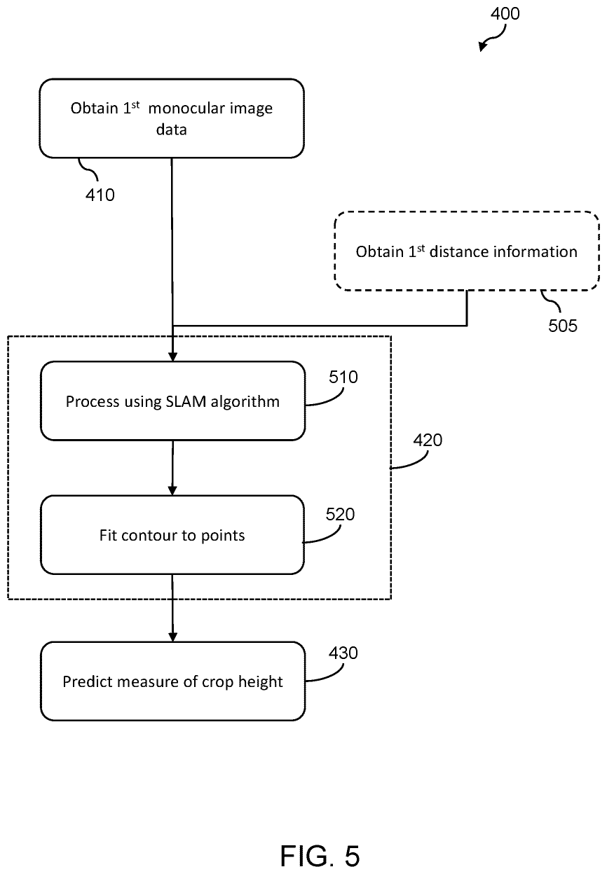

FIG. 5 illustrates an embodiment of method 400 that employs one example approach for performing step 420. This approach makes use of the first monocular image data (obtained in step 410) and first movement information (obtained in a step 505).

The first monocular image data comprises a first sequence of monocular images. Each monocular image contains a representation of the portion of the crop before harvesting by the harvesting machine.

The first movement information identifies a movement of the harvesting machine between capturing adjacent monocular images in the first sequence of monocular images.

By way of example only, the first movement information may be distance information that identifies a distance between adjacent monocular images in the first sequence of images. Such distance information may, for example, be derived from a speed of the harvesting machine and a time elapsed between capturing each monocular image. Suitable components for obtaining such forms of data are well known to the skilled person, e.g., using a tachometer, speedometer, accelerometer (and/or other form of inertial measurement unit) and/or satellite navigation systems. As another example, the distance information may be derived from navigation information identifying, for each monocular image, a position at which the monocular image was captured.

As another example, the first movement information may be inertia information that identifies a change in inertia between adjacent monocular images within the sequence. Such information can, for instance, be generated by an accelerometer or other form of inertial measurement unit.

Accordingly, the method 400 may comprise a step 505 of obtaining first movement information. As previously explained, the first movement information may be produced by deriving distance information or inertia information from other forms of data (e.g., speed information and/or navigation information).

The step 420 of processing the first monocular image data comprises a sub-step 510 of processing the first sequence of monocular images (and no other image data) together with the first movement information using a first monocular simultaneous localization and mapping, SLAM, algorithm to produce a plurality of first points. Each first point identifies a predicted location of a portion of a top of the crop with respect to a co-ordinate system, e.g. a 3D co-ordinate system or 2D co-ordinate system. Examples of suitable SLAM algorithms for producing such a plurality of first points are described later in this disclosure.

The step 420 also comprises a sub-step 420 of fitting a contour (sometimes called a surface) to the first points to produce a first contour that represents the top of the crop. Approaches to fitting a contour or surface to a plurality of first points are well known in the art. Such approaches may, for instance, comprise ignoring outlying points and fitting a contour or surface of best fit that aligns with the first points.

Examples of suitable approaches are described by: Hackel, Timo, Jan D. Wegner, and Konrad Schindler. “Contour detection in unstructured 3D point clouds.” Proceedings of the IEEE conference on computer vision and pattern recognition. 2016; Mitra, Niloy J., and An Nguyen. “Estimating surface normals in noisy point cloud data.” Proceedings of the nineteenth annual symposium on Computational geometry. 2003; or Berger, Matthew, et al. “A survey of surface reconstruction from point clouds.” Computer graphics forum. Vol. 36. No. 1. 2017.

The method 400 then performs the step 430 of predicting a measure of crop height, making use of the first contour.

One effect of using a SLAM algorithm is that the relative position of the camera capturing the monocular images processed by the SLAM algorithm is determined (i.e., localized). If the position of the camera with respect to a ground surface is determinable or otherwise known (e.g., at a known fixed position-as would be the case for a camera on a harvesting machine), then the relative position of the first contour with respect to a ground surface can be trivially determined. Thus, it is possible to determine, using the first contour, a measure of crop height, e.g., a height of the crop between the top of the crop (defined by the first contour) and the ground surface.

Moreover, if the position of the cutting bar of the header is known or determinable, e.g., using one or more sensors, then it is possible to trivially determine a measure of crop height between the top of the crop (defined by the first contour) and the cutting bar—i.e. the height h₁ illustrated in FIG. 3. This can, for instance, be simply determined by subtracting the known distance between the cutting bar and the ground surface from a determined height between the top of the crop and the ground surface.

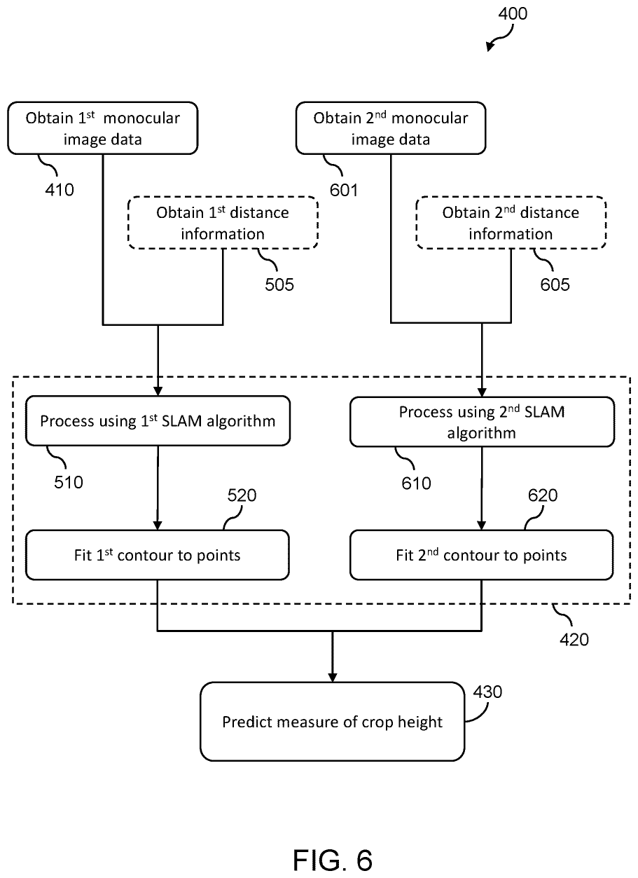

FIG. 6 illustrates another embodiment of method 400 that employs another example approach for performing step 420. This approach makes use of the first monocular image data (obtained in step 410), first movement information (obtained in a step 505), second monocular image data (obtained in a step 601) and second movement information (obtained in a step 605).

As in the previous embodiment, the first monocular image data comprises a first sequence of monocular images, each monocular image containing a representation of the portion of the crop before harvesting by the harvesting machine. Similarly, the first movement information identifies a movement of the harvesting machine between capturing adjacent monocular images in the first sequence of monocular images.

The second monocular image data comprises a second sequence of monocular images. The second monocular image data comprises a second sequence of monocular images each containing a representation of stubble and/or ground surface remaining after harvesting of the crop by the harvesting machine and/or the cutting bar of the header.

The second movement information identifies a movement travelled by the harvesting machine between capturing adjacent monocular images in the second sequence of monocular images. The second movement information may be analogous to the first movement information, and may comprise/contain similar data obtained in a similar manner.

The step 420 in method 400 illustrated by FIG. 6 also comprises steps 510, 520, which are embodied as previously described.

The step 420 in method 400 illustrated by FIG. 6 further comprises a sub-step 510 of processing the second sequence of monocular image data, and no other image data, together with the second movement information using a second monocular simultaneous localization and mapping, SLAM, algorithm to produce a plurality of second points. Each identifying a predicted location of a portion of a top of the stubble and/or ground surface and/or cutting bar represented in the second sequence of monocular images.

The step 420 in method 400 illustrated by FIG. 6 further comprises a sub-step 520 of fitting a contour to the second points to produce a second contour that represents the stubble and/or ground surface and/or cutting bar with respect to the co-ordinate system.

The step 430 of predicting the measure of crop height comprises processing the first contour and the second contour to predict the measure of crop height of the crop, represented in the monocular image data.

It will be appreciated that step 430 may be iteratively performed to produce a plurality of different measures of crop height, e.g., at different crop harvesting locations. It may not be necessary to repeat steps 410 and 420 to repeat step 430, but this can, of course, be optionally performed.

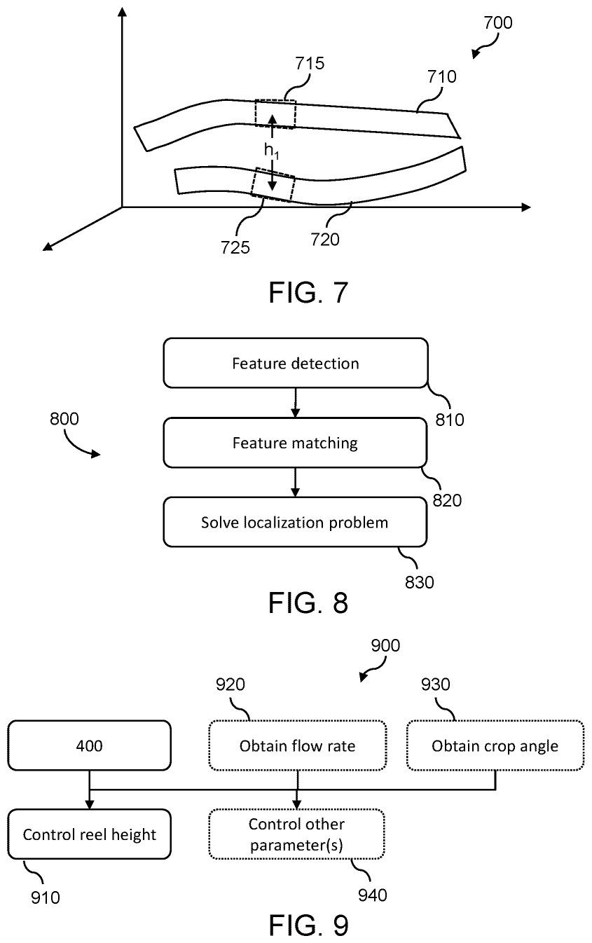

FIG. 7 conceptually illustrates an approach for performing step 430. FIG. 7 conceptually illustrates the co-ordinate system 700 in which the first contour 710 and second contour is defined.

Step 430 may be performed by identifying a first portion 715 of the first contour 710 and identifying a second portion 725 of the second contour 720. The first portion of the first contour wholly overlays the second portion of the second contour in a vertical direction within the co-ordinate system. Subsequently, a vertical distance or average vertical distance within the co-ordinate system between the first portion of the first contour and the second portion of the second contour can be determined to predict the measure of crop height.

This approach effectively provides a mechanism for predicting a (e.g., average) distance or height h₁ between the top of a crop, at a particular crop location or crop locations, and the top of the stubble produced after harvesting said crop (i.e., the position of the cutting bar during harvesting said crop) at the same said crop location or crop locations.

In preferred examples, the first portion 715 of the first contour 710 comprises more than one point of the first contour 710 and the second portion 725 of the second contour 720 comprises more than one point of the second contour. The vertical distance or average vertical distance may, in this case, therefore be the average vertical difference. This approach helps to reduce the impact or effect of noise on a determined measure of crop height.

In preferred examples, the first portion 715 of the first contour represents a portion of the top of crop (to be harvested or that has been harvested) that would be or was harvested within a time period of between 1 second and 10 minutes, e.g., between 5 seconds and 60 seconds.

It will be apparent that in the previously described approach, the measure of crop height is only determined or determinable after the crop has been harvested. This is because the second contour cannot be produced until the stubble/ground surface remaining, after harvesting, at a particular harvesting location after harvesting is available.

In a variation to the approach described with reference to FIG. 7, the second contour may instead be processed to predict a location of a second portion that would underly the first portion if harvesting is continued. This can be performed, for instance, be extrapolating the second contour. The previously described approach can then be applied, mutatis mutandis. This provides a mechanism for predictive determination of the measure of crop height, e.g., before the crop has been harvested.

The approaches illustrated by FIGS. 5 to 7 make use of one or more SLAM algorithms to process (first and optionally second) monocular image data in order to produce a cloud of points. Suitable SLAM algorithms that are able to process monocular image data in the way are known in the art.

By way of example, one suitable SLAM algorithm for use in processing monocular image data is set out by Campos, Carlos, et al. “Orb-slam3: An accurate open-source library for visual, visual-inertial, and multimap slam.” IEEE Transactions on Robotics 37.6 (2021 ): 1874-1890. As an open-source function, the Orb-slam 3 library is continually updated to reflect developments of the SLAM algorithm, any of which can be used in proposed embodiments.

Another suitable SLAM algorithm for use in processing monocular image data is set out by Davison, Andrew J. “Real-time simultaneous localisation and mapping with a single camera.” Computer Vision, IEEE International Conference on. Vol. 3. IEEE Computer Society, 2003.

FIG. 8 conceptually illustrates a procedure or method 800 performed by a monocular SLAM algorithm. The method 800 is performs on a series or sequence of monocular image that form monocular image data.

The method 800 comprises a feature detection step 810 comprises detecting, in each monocular image, the most significant features (e.g., in a region of interest). Suitable algorithms for detecting features within a monocular image are well established in the art, including SIFT (Scale Invariant Feature Transform), ORB, BRISK (Binary Robust Invariant Scalable Keypoints) or KAZE.

Various approaches for feature detection are set out by Tareen, Shaharyar Ahmed Khan, and Zahra Saleem. “A comparative analysis of sift, surf, kaze, akaze, orb, and brisk.” 2018 International conference on computing, mathematics and engineering technologies (iCoMET). IEEE, 2018.

One approach for detecting significant features that could be used is suggested by Leutenegger, Stefan, Margarita Chli, and Roland Y. Siegwart. “BRISK: Binary robust invariant scalable keypoints.” 2011 International conference on computer vision. leee, 2011. Another approach is suggested by Alcantarilla, Pablo Fernandez, Adrien Bartoli, and Andrew J. Davison. “KAZE features.” Computer Vision-ECCV 2012:12th European Conference on Computer Vision, Florence, Italy, Oct. 7-13, 2012, Proceedings, Part VI 12. Springer Berlin Heidelberg, 2012. Yet another approach is suggested by Huang, Feng-Cheng, et al. “High-performance SIFT hardware accelerator for real-time image feature extraction.” IEEE Transactions on Circuits and Systems for Video Technology 22.3 (2011 ): 340-351.

The method 800 also comprises a feature matching step 820 comprising matching features from image to image, resulting in M match pairs of matched features between each pair of adjacent images. The method 800 also comprises a localization problem solving step 830 that comprises estimating, using the known (from the distance information) physical distance between two adjacent images in each pair, the (3D) position of each matching feature in a co-ordinate system. These follow standard approaches used in SLAM algorithmic processing.

In this way, a cloud of points is constructed, each point representing a location of a feature that is identified or represented in at least two images of the sequence of monocular images.

With reference back to FIG. 4, although above-described embodiments make use of one or more monocular SLAM algorithms to process the (first) monocular image data in order to predict the measure of crop height, alternative approaches could be used.

By way of example, an alternative approach for performing step 420 is to make use of a machine-learning method. Thus. the step 420 of processing the first monocular image data may comprise processing the first monocular image data using a machine-learning method to predict the measure of crop height. Thus, the first monocular image data may be input to the machine-learning method, which outputs the predicted measure of crop height.

In preferred examples of this approach, step 420 comprises processing no other image data that contains a representation of the portion of the crop using the machine-learning method. However, other forms of image data, e.g., containing a representation of the stubble or ground surface after harvesting of the crop, could be used as input to the machine-learning method in other examples.

Some embodiments therefore make use of one or more machine-learning algorithms. Any suitable machine-learning algorithm may be used in different embodiments for the present disclosure. Suitable machine-learning algorithms include (artificial) neural networks, support vector machines (SVMs), Naïve Bayesian models and decision tree algorithms, although other appropriate examples will be apparent to the skilled person.

There are a number of well-established approaches for training a machine-learning algorithm. Typically, such training approaches make use of a large database of known input and output data. The machine-learning algorithm is modified until an error between predicted output data, obtained by processing the input data with the machine-learning algorithm, and the actual (known) output data is close to zero, i.e. until the predicted output data and the known output data converge. The value of this error is often defined by a cost function. The precise mechanism for modifying the machine-learning algorithm depends upon the type of model. Example approaches for use with a neural network include gradient descent, backpropagation algorithms and so on.

For use in the above-described approach, the known input data comprises example instances of monocular image data. The corresponding known output data comprises, for each example instance of monocular image data, a measure of crop height of crop represented in the monocular image data. The segmented images may be produced by an individual or device physically obtaining and recorded (e.g., using a measuring stick or the like) a measure of the crop height of the crop represented in the instance of monocular image data.

The skilled person will appreciate how different forms of known input and output data can be used dependent upon the function or purpose of the machine-learning algorithm.

FIG. 9 illustrates a computer-implemented method 900 of controlling one or more parameters of a harvesting machine.

The computer-implemented method 900 comprises a process 400 of determining the measure of crop height of harvested crop by performing a previously described method.

The computer-implemented method 900 also comprises a step 910 of adjusting the height of the reel of the header responsive to the determined measure of crop height of the harvested crop.

In particular, the height of the reel of the header may be adjusted such that the tines carried by the tine bars of the reel engage with the top of the crop to a desired extent. The precise extend may depend upon user preference, grain or crop type, crop conditions, weather conditions, saturation levels and so on.

By way of example only, a typical header for a combine harvester allows for control over the distance between the reel and the cutting bar. If a proposed method defines the measure of crop height as a distance between the cutting bar and the top of the crop when the crop is harvested (e.g., a distance h₁ as illustrated in FIG. 4), then the distance between the reel and cutting bar may be controlled such that the tines of the reel engage with the top of the crop to a desired extent.

In particularly preferable examples, step 910 comprises adjusting the height of the reel of the header, e.g., with respect to the cutting bar, to maintain (e.g., on average) a same level of engagement (e.g., a same average amount of projection into) the top of the crop. Thus, one or more other parameters may define a desired measure of crop height, which is maintained by using the determined measure of crop height as feedback.

Step 910 may be iteratively performed, e.g., once a minute, once an hour, once every 6 hours or once a day.

Thus, one or more measures of crop heights obtained via one or more iterations of process 400 may be obtained and averaged. In particular, the one or more measure of crop height may contain measures obtained over a large period of time, e.g., at least one minute, more preferably at least one hour and more preferably at least 6 hours. The one or more measures may comprise no less than 20 measures, e.g., no less than 50 measures.

The average measure of crop height may be used in step 910 to adjust the height of the reel of the header. In this way, the control over height of the reel of the header may effectively be a slow responding control loop.

Method 900 may be adapted such that one or more other measures or parameters are used in controlling the reel height.

By way of example, method 900 may comprise a step 920 of obtaining a flow rate of crop through the elevator housing (e.g., into the threshing unit). Approaches for determining a flow rate are well established in the art. The height of the reel may be controlled responsive to this determined flow rate. For instance, if a flow rate falls below a predetermined threshold, the height of the reel may be reduced. The determined measure of crop height may then be used to maintain the height of the reel at this reduced level for ongoing crop harvesting.

As another example method 900 may comprise a step 930 of obtaining a crop angle, being an angle at which crop (to be harvested) lies. Approaches for determining a crop angle are established in the art. The height of the reel may be controlled further responsive to the crop height.

The method 900 may also comprise modifying or controlling 940 one or more other parameters responsive to any parameters obtained in method 900, including the measure of crop height. It is herein appreciated that the measure of crop height can influence a desired value for other parameters of the harvesting machine, e.g., reel for/aft position, header pitch angle and so on.

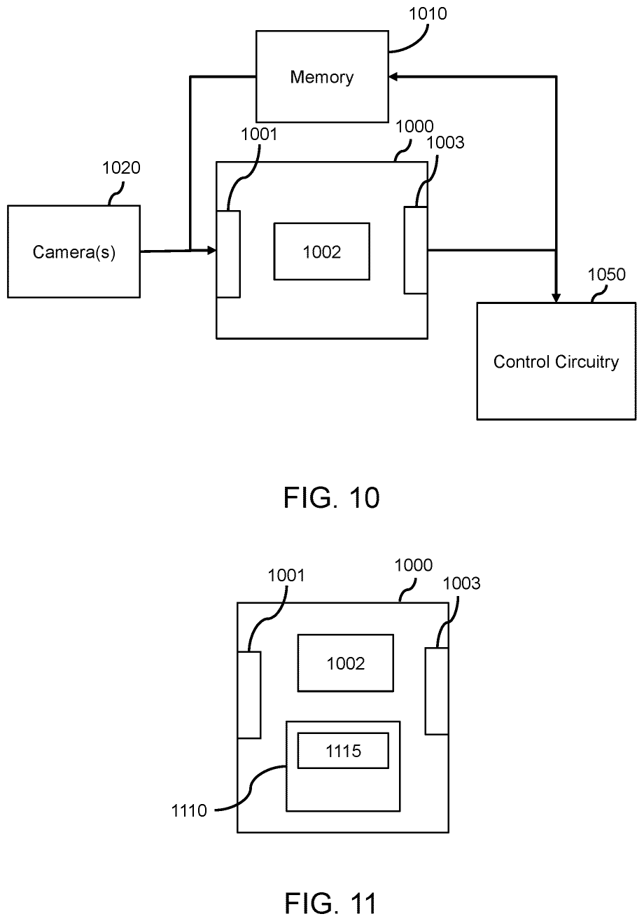

FIG. 10 illustrates a processing system 1000 according to an embodiment. The processing system is configured to perform any herein described method 400, 900.

The processing system 1000 may thereby obtain at least first monocular image data containing a representation of a portion of the crop before harvesting by a harvesting machine. The first monocular image data is captured using a single camera mounted on the harvesting machine.

Of course, where relevant, the processing system may receive the first movement information, the second monocular image data and/or the second movement information.

The processing system may receive these values from a memory or storage unit 1010 and/or from the camera 1020.

The processing system 1000 may comprise an input interface 1001 configured to receive all of the above-identified data.

The processing system 1000 is configured to at least the first monocular image data using one or more image processing algorithms to predict the measure of crop height. Procedures for performing this method/process have been previously described. This process may be carried out by a processing unit 1002 of the processing system 1000.

The processing system 1000 may be to output the predicted measure of crop height. Any output of the processing system may be provided via an output interface 1003. In particular, the output of the processing system may be defined by the processing unit 1002 of the processing system via the processing unit.

In some examples, the processing system 1000 is configured to control the operation or parameters of one or more features of a harvesting machine via control circuitry 1050. Thus, the processing system may provide a control signal to control circuitry 1050 for modifying one or more parameters of the harvesting device (not shown).

In some examples, the predicted measure of crop height is used to control a user interface, such as a display. This may be used, for instance, to provide at a user interface, a visual representation of the predicted measure of crop height.

In some examples, any data produced by the processing unit, e.g., the predicted measure of crop height, is stored in the memory 1010.

FIG. 11 illustrates an embodiment of the processing system 1000 described with reference to FIG. 10. The processing system is able to carry out or perform one or more embodiments of an invention, e.g. for predicting a measure of crop height.

The processing system 1000 comprises an input interface 1001 that receives communications from one or more inputting devices. Examples of suitable inputting devices include external memories, cameras and so on.

The processing system 1000 also comprises a processing unit 1002.

In one example, the processing unit 1002 may comprise an appropriately programmed or configured single-purpose processing device. Examples may include appropriately programmed field-programmable gate arrays or complex programmable logic devices.

As another example, the processing unit may comprise a general purpose processing system (e.g. a general purpose processor or microprocessor) that executes a computer program 1115 comprising code (e.g. instructions and/or software) carried by a memory 1110 of the processing system 1000.

The memory 1110 may be formed from any suitable volatile or non-volatile computer storage element, e.g. FLASH memory, RAM, DRAM, SRAM, EPROM, PROM, CD-ROM and so on. Suitable memory architectures and types are well known to the person skilled in the art.

The computer program 1115, e.g. the software, carried by the memory 1110 may include comprise a sequence of instructions that are executable by the processing unit for implementing logical functions to carry out the desired method or procedure. Each instruction may represent a different logical function, step or sub-step used in performing a method or process according to an embodiment. The computer-program may be formed from a set of sub-programs, as would be known to the skilled person. The computer program 1115 may be written in any suitable programming language that can be interpreted by the processing unit 1002 for executing the instructions. Suitable programming languages are well known to the skilled person.

The processing system 1000 also comprises an output interface 1003. The processing system may be configured to provide information, such as the indicator(s), via the output interface. In some examples, the processing system may be configured to control one or more other devices connected to the output interface 1003 by providing appropriate control signals to the one or more other devices. Suitable control examples include controlling a user-perceptible output such as a visual or audible representation at a user interface.

Different components of the processing system 1000 may interact or communicate with one another via one or more intra-system communication systems (not shown), which may include communication buses, wired interconnects, analogue electronics, wireless communication channels (e.g. the internet) and so on. Such intra-system communication systems would be well known to the skilled person.

It is not essential for the processing system 1000 to be formed on a single device, e.g. a single computer. Rather, any of the system blocks (or parts of system blocks) of the illustrated processing system may be distributed across one or more computers.

The skilled person would be readily capable of developing a processing system for carrying out any herein described method. Thus, each step of the flow chart may represent a different action performed by a processing system, and may be performed by a respective module of the processing system.

It will be understood that disclosed methods are preferably computer-implemented methods. As such, there is also proposed the concept of a computer program comprising code means for implementing any described method when said program is run on a processing system, such as a computer. Thus, different portions, lines or blocks of code of a computer program according to an embodiment may be executed by a processing system or computer to perform any herein described method.

A computer program may be stored on a computer-readable medium, itself an embodiment of the invention. A “computer-readable medium” is any suitable mechanism or format that can store a program for later processing by a processing unit. The computer readable medium can be, for example but not limited to, an electronic, magnetic, optical, electromagnetic, infrared, or semiconductor system, apparatus or device. The computer-readable medium is preferably non-transitory.

In some alternative implementations, the functions noted in the block diagram(s) or flow chart(s) may occur out of the order noted in the figures. For example, two blocks shown in succession may, in fact, be executed substantially concurrently, or the blocks may sometimes be executed in the reverse order, depending upon the functionality involved.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. If a computer program is discussed above, it may be stored/distributed on a suitable medium, such as an optical storage medium or a solid-state medium supplied together with or as part of other hardware, but may also be distributed in other forms, such as via the Internet or other wired or wireless telecommunication systems. If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa. Any reference signs in the claims should not be construed as limiting the scope.

All references cited herein are incorporated herein in their entireties. If there is a conflict between definitions herein and in an incorporated reference, the definition herein shall control.

1. A computer-implemented method of predicting a measure of crop height of crop, the computer-implemented method comprising:
obtaining first monocular image data containing a representation of a portion of the crop before harvesting by a harvesting machine, the first monocular image data being captured using a single camera mounted on the harvesting machine; and
processing the first monocular image data using one or more image processing algorithms to predict the measure of crop height.

2. The computer-implemented method of claim 1, further comprising obtaining second monocular image data containing a representation of stubble and/or ground surface remaining after harvesting of the crop by the harvesting machine and/or a cutting bar of the harvesting machine,
wherein processing the first monocular image data comprises processing the first monocular image data and the second monocular image data to predict the measure of crop height.

3. The computer-implemented method of claim 1, wherein the measure of crop height is a prediction of a distance between a top of the stubble and/or ground surface, represented in the second monocular image data, and a top of the crop, represented in the first monocular image data.

4. The computer-implemented method of claim 1, wherein:
the first monocular image data comprises a first sequence of monocular images, each monocular image containing a representation of the portion of the crop before harvesting by the harvesting machine;
the computer-implemented method further comprises obtaining first movement information identifying a movement of the harvesting machine between capturing adjacent monocular images in the first sequence of monocular images;
the step of processing the first monocular image data comprises:
processing the first sequence of monocular images, and no other image data, together with the first movement information using a first monocular simultaneous localization and mapping, SLAM, algorithm to produce a plurality of first points, each identifying a predicted location of a portion of a top of the crop with respect to a co-ordinate system; and
processing the plurality of first points to predict the measure of crop height.

5. The computer-implemented method of claim 4, wherein the step of processing the plurality of first points comprises:
fitting a contour to the first points to produce a first contour that represents the top of the crop; and
processing the first contour to predict the measure of crop height.

6. The computer-implemented method of claim 4, further comprising:
obtaining second monocular image data comprising a second sequence of monocular images each containing a representation of stubble and/or ground surface remaining after harvesting of the crop by the harvesting machine;
obtaining second movement information identifying a movement travelled by the harvesting machine between capturing adjacent monocular images in the second sequence of monocular images; and
processing the second sequence of monocular image data, and no other image data, together with the second movement information using a second monocular simultaneous localization and mapping, SLAM, algorithm to produce a plurality of second points, each identifying a predicted location of a portion of a top of the stubble and/or ground surface represented in the second sequence of monocular images,
wherein the step of processing the plurality of first points comprises processing the plurality of first points and the plurality of second points to predict the measure of crop height.

7. The computer-implemented method of claim 6, wherein:
the step of processing the plurality of first points comprises fitting a contour to the second points to produce a second contour that represents the stubble and/or ground surface with respect to the co-ordinate system; and
the step of processing the first contour comprises processing the first contour and the second contour to predict the measure of crop height.

8. The computer-implemented method of claim 7, wherein the step of processing the first contour and the second contour comprises:
identifying a first portion of the first contour;
identifying a second portion of the second contour, the first portion of the first contour wholly overlaying the second portion of the second contour in a vertical direction within the co-ordinate system; and
determining a vertical distance or average vertical distance within the co-ordinate system between the first portion of the first contour and the second portion of the second contour to predict the measure of crop height of the crop.

9. The computer-implemented method of claim 8, wherein:
the first portion of the first contour comprises more than one point of the first contour;
the second portion of the second contour comprises more than one point of the second contour; and
the vertical distance or average vertical distance is the average vertical difference.

10. The computer-implemented method of claim 6, wherein the first sequence of monocular images and the second sequence of monocular images are the same, such that each monocular image contains a representation of a portion of crop before harvesting by the harvesting machine and a portion of a top of the stubble and/or ground surface after harvesting of the crop by the harvesting machine.

11. The computer-implemented method of claim 4, wherein the first movement information is derived from:
a speed of the harvesting machine and a time elapsed between capturing each monocular image; and/or
navigation information identifying, for each monocular image, a position at which the monocular image was captured.

12. The computer-implemented method of claim 1, wherein the step of processing the first monocular image data comprises processing the first monocular image data using a machine-learning method to predict the measure of crop height.

13. A computer-implemented method of controlling the height of a reel of a header of a harvesting machine, the computer-implemented method comprising:
determining the measure of crop height by performing the method of claim 1; and
adjusting the height of the reel of the header responsive to the determined measure of crop height.

14. A computer program product comprising computer program code means which, when executed on a computing device having a processing system, cause the processing system to perform all of the steps of the computer-implemented method according to claim 1.

15. A processing system configured to predict a measure of crop height of a crop, the processing system being configured to:
obtain first monocular image data containing a representation of a portion of the crop before harvesting by a harvesting machine, the first monocular image data being captured using a single camera mounted on the harvesting machine; and
process the first monocular image data using one or more image processing algorithms to predict the measure of crop height.
